(19) United States
(12) Patent Application Publication
(10) Pub. No.: US 2026/0168937 A1
(43) Pub. Date: Jun. 18, 2026

(54) Welding Quality Inspection Device for Secondary Batteries

(71) Applicant: SK On Co., Ltd., Seoul (KR)

(72) Inventors: Hyung Gi KIM, Daejeon (KR); Seung Han LEE, Daejeon (KR)

(21) Appl. No.: 19/413,074

(22) Filed: Dec. 9, 2025

(30) Foreign Application Priority Data
Dec. 12, 2024 (KR) 10-2024-0185220

(51) Int. Cl. G01N 21/88; G01N 21/95

(52) U.S. Cl. CPC G01N 21/8851; G01N 21/95

(57) ABSTRACT

Proposed is a welding quality inspection device for a secondary battery. The welding quality inspection device for a secondary battery includes a ring slide portion disposed spaced apart from an inspection target and provided in a form having a predetermined curvature, a carrier portion mounted on the ring slide portion and provided to be movable along the ring slide portion, a gripper portion extending from the carrier portion toward the inspection target and provided to maintain a predetermined distance from the inspection target, a camera portion mounted on the carrier portion to move along the ring slide portion, the camera portion being arranged respectively on an upper side and a lower side of the gripper portion to capture the inspection target from a plurality of angles, and a driving portion for driving the carrier portion.

### CROSS REFERENCE TO RELATED APPLICATION

The present application claims priority to Korean Patent Application No. 10-2024-0185220, filed on Dec. 12, 2024, the entire contents of which are incorporated herein for all purposes by this reference.

### BACKGROUND

### Technical Field

The present disclosure relates to a welding quality inspection device for a secondary battery.

### Description of the Related Art

Recently, various studies have been actively conducted along with the development of secondary batteries. In products using secondary batteries, a lead tab (hereinafter, referred to as a “tab portion”) is used as a connection terminal with an external circuit, and welding quality of the tab portion serves as an important factor directly related to performance and stability of the secondary battery.

The tab portion is connected to an electrode of the secondary battery, and is required to be sealed and insulated from the outside of the case. Accordingly, securing reliability of welding quality in a manufacturing process is very important, and particularly, it is important to accurately evaluate a welding state between the tab portion and an electrode assembly.

Conventionally, welding quality inspection of the secondary battery mainly evaluates a welding state of the tab portion on the basis of images captured at limited angles by using a vision camera fixed at a specific position.

When welding quality of the secondary battery is inspected from a fixed position as described above, images can be obtained only from a specific angle of the welded portion, so welding defects occurring at other arbitrary angles may not be detected.

In addition, the quality of the captured image may greatly vary depending on working environments such as an angle and illuminance of illumination, so the working environment, in which the welding quality inspection is performed, is also important in maintaining consistency in quality.

Accordingly, there is a demand for a device capable of improving welding quality by acquiring high-quality captured images by varying angles from various directions while maintaining constant illuminance rather than capturing the inspection target from a fixed position in welding quality inspection of the secondary battery.

### RELATED ART DOCUMENTS

### Patent Document

(Patent Document 1) Korean Patent No. 10-2667808 B1

### SUMMARY

According to an aspect of the present disclosure, a welding quality inspection device for a secondary battery is provided, which is capable of capturing from various angles instead of simply capturing an inspection target from a fixed position and which is capable of stably securing high-quality images even in working environments where illuminance varies.

According to another aspect of the present disclosure, a welding quality inspection device for a secondary battery is provided, which can be widely applied to green technology fields such as electric vehicles, battery charging stations, solar power generation and wind power generation utilizing batteries, and the like.

A welding quality inspection device for a secondary battery according to an exemplary embodiment of the present disclosure includes a ring slide portion disposed spaced apart from an inspection target and provided in a form having a predetermined curvature, a carrier portion mounted on the ring slide portion and provided to be movable along the ring slide portion, a gripper portion extending from the carrier portion toward the inspection target and provided to maintain a predetermined distance from the inspection target, a camera portion mounted on the carrier portion to move along the ring slide portion, the camera portion being arranged respectively on an upper side and a lower side of the gripper portion to capture the inspection target from a plurality of angles, and a driving portion for driving the carrier portion.

Herein, the welding quality inspection device for the secondary battery may further include a distance adjustment portion for adjusting a distance between the ring slide portion and the inspection target.

In addition, the distance adjustment portion may include a moving plate portion connected to the ring slide portion, a moving rail portion for guiding the moving plate portion to move forward toward or backward from the inspection target, and a ball screw portion connected to the moving plate portion to move the moving plate portion by converting rotational motion into linear motion.

In addition, the welding quality inspection device for the secondary battery may further include a height adjustment portion for adjusting a height of the ring slide portion.

In addition, the ring slide portion may include a ring guide for guiding movement of the carrier portion and for preventing the carrier portion from being separated, and a ring gear portion disposed spaced apart from the ring guide and having a gear formed on an outer surface.

In addition, the carrier portion may include a guide roller coupled to the ring guide for guiding the carrier portion along the ring slide portion without being separated.

The gripper portion may include a holder portion disposed close to a tab portion of the electrode assembly when the inspection target is an electrode assembly.

The camera portion may be provided to capture a welded portion between the electrode assembly and the tab portion when the inspection target is an electrode assembly.

The camera portion may further include a lighting portion for providing light to an imaging region of the inspection target.

The driving portion may include a servo motor, and a pinion gear portion for transmitting power of the servo motor to the ring gear portion.

The welding quality inspection device for the secondary battery may further include a controller for controlling the driving portion so that the camera portion can capture the inspection target from a preset initial position to a final position.

In addition, when the inspection target is an electrode assembly, the controller may control the driving portion so that the carrier portion can be positioned at a location where the gripper portion is aligned in a straight line with a tab portion of the electrode assembly before the start of imaging and after the end of imaging of the camera portion.

In addition, when the location where the gripper portion is aligned in a straight line with the tab portion of the electrode assembly is assumed as 0 degrees, the controller may control the driving portion so that among a plurality of camera portions, the camera portion on the upper side of the gripper portion can capture images within a range of +45 degrees to +15 degrees, and the camera portion on the lower side of the gripper portion can capture images within a range of −15 degrees to −45 degrees.

In addition, the controller may control the camera portion to capture images at preset angular intervals within an imaging angle range of the camera portion.

The features and advantages of the present disclosure will become more apparent from the following detailed description based on the accompanying drawings.

Prior to this, terms or words used in the present specification and claims should not be interpreted in a conventional and dictionary sense, but should be interpreted as meaning and concept consistent with the technical idea of the present disclosure on the basis of the principle that an inventor may appropriately define the concept of terms in order to best describe the inventor's invention.

According to an exemplary embodiment of the present disclosure, it is possible to improve reliability of the quality inspection by capturing at various angles and maintaining constant illuminance when inspecting the welding quality of the secondary battery.

### BRIEF DESCRIPTION OF THE DRAWINGS

FIG. 1 is a perspective view illustrating a welding quality inspection device for a secondary battery according to an exemplary embodiment of the present disclosure.

FIG. 2 is a side view of FIG. 1 as viewed from a direction “A”.

FIG. 3 is a rear perspective view illustrating a rear portion of a welding quality inspection device for a secondary battery according to an exemplary embodiment of the present disclosure.

FIG. 4 is a side view of FIG. 3 as viewed from a direction “B”.

FIG. 5 is an enlarged view of section “C” of FIG. 4.

FIG. 6A is an enlarged view of section “D” of FIG. 4.

FIG. 6B is an operational state view illustrating a relationship change between a gripper portion and an inspection target according to movement of a carrier portion.

FIG. 7 is an enlarged view of section “E” of FIG. 4.

FIG. 8 is a block diagram illustrating a control configuration of a controller according to an exemplary embodiment of the present disclosure.

FIG. 9 is an operational state view illustrating a state before starting an inspection and after finishing an inspection in a welding quality inspection device for a secondary battery according to an exemplary embodiment of the present disclosure.

FIGS. 10 and 11 are operational state views illustrating a state of performing an inspection in a welding quality inspection device for a secondary battery according to an exemplary embodiment of the present disclosure.

### DETAILED DESCRIPTION OF THE DISCLOSURE

The term used to describe an exemplary embodiment of the present disclosure may not be intended to limit the present disclosure. It should be noted that singular expressions include plural expressions unless otherwise specified in the context.

When assigning reference numbers to components in a drawing, identical components may be assigned the same reference numbers as much as possible even when shown on different drawings, and similar components may be assigned similar reference numbers.

The drawings may be schematic or exaggerated for the purpose of illustrating the exemplary embodiments. In the present document, expressions such as “have,” “may have,” “include,” or “may include” may refer to the presence of a corresponding feature (e.g., numerical values, functions, operations, or elements such as components), and may not preclude the presence of additional features.

Terms such as “one,” “other,” “another,” “first,” and “second” may be used to distinguish one component from another, and the components may not be limited by these terms.

Hereinafter, an exemplary embodiment of the present disclosure will be described in detail with reference to the accompanying drawings.

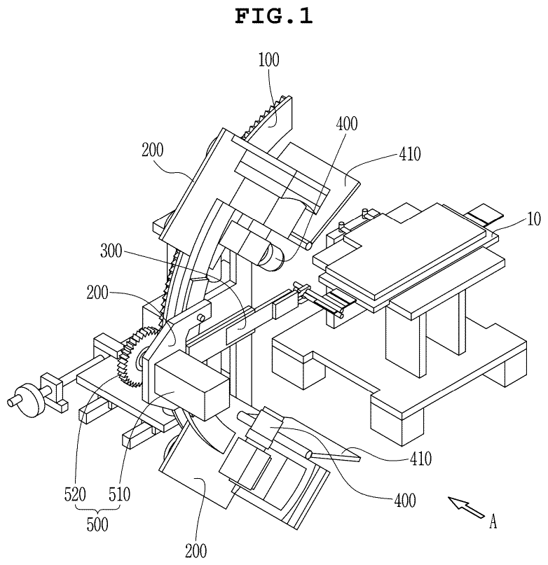

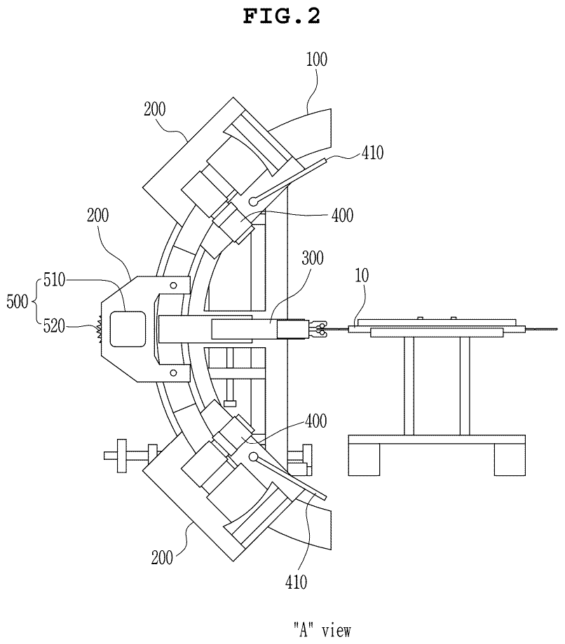

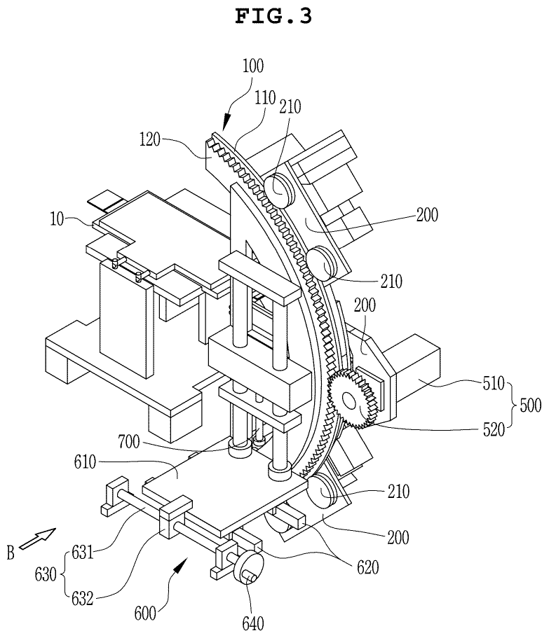

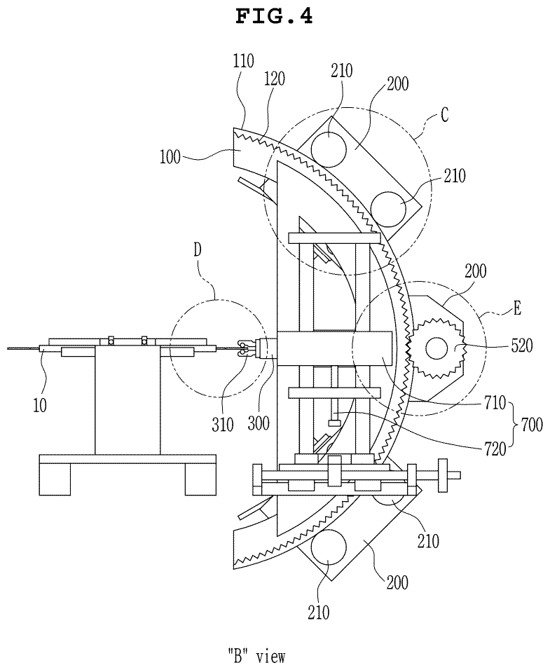

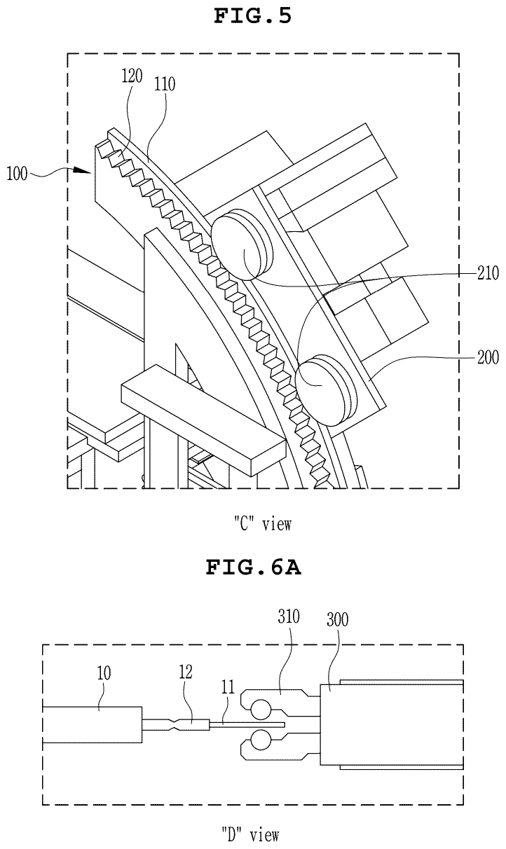

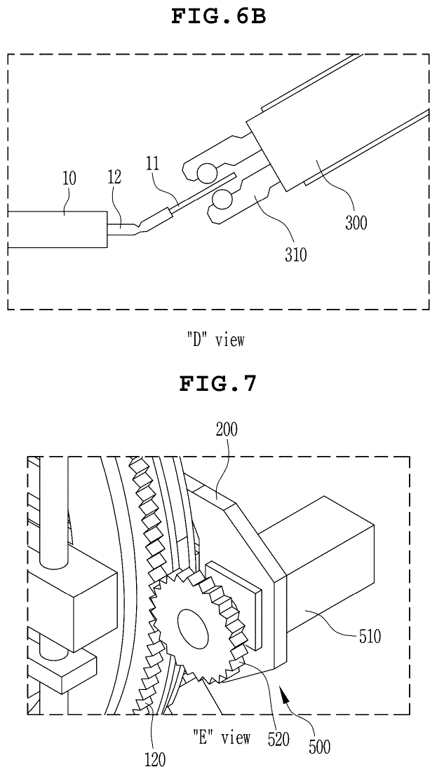

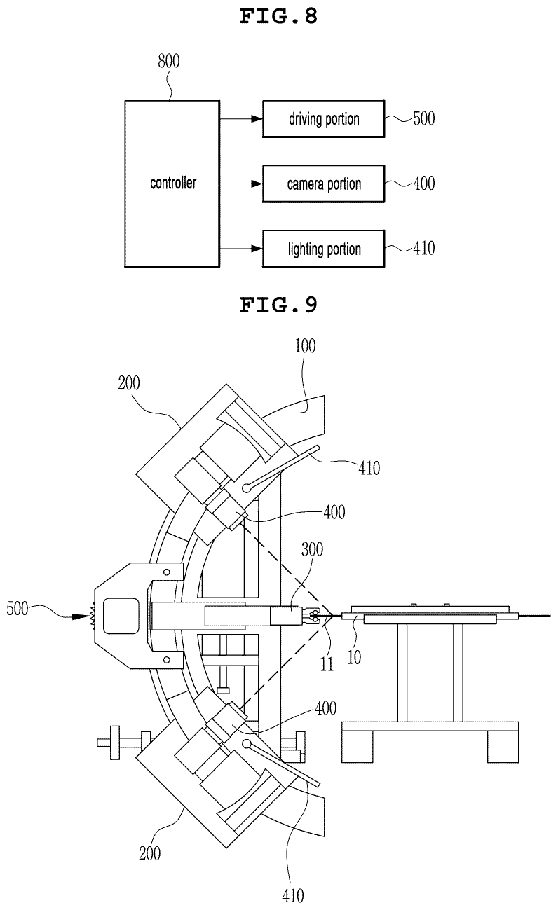

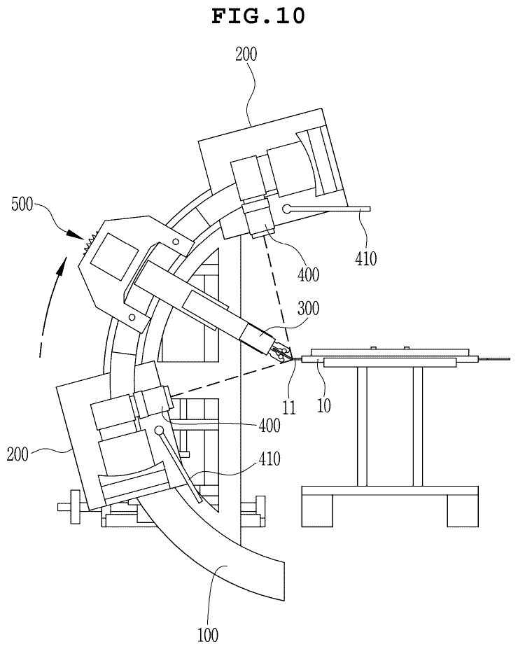

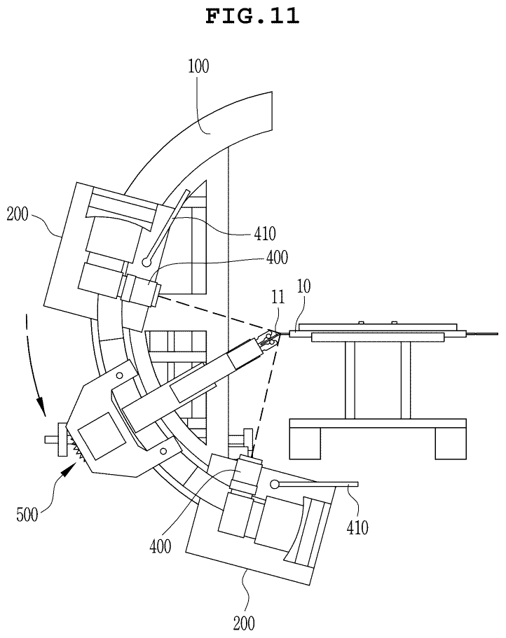

FIG. 1 is a perspective view illustrating a welding quality inspection device for a secondary battery according to an exemplary embodiment of the present disclosure, FIG. 2 is a side view of FIG. 1 as viewed from a direction “A”, FIG. 3 is a rear perspective view illustrating a rear portion of a welding quality inspection device for a secondary battery according to an exemplary embodiment of the present disclosure, FIG. 4 is a side view of FIG. 3 as viewed from a direction “B”, FIG. 5 is an enlarged view of section “C” of FIG. 4, FIG. 6A is an enlarged view of section “D” of FIG. 4, FIG. 6B is an operational state view illustrating a relationship change between a gripper portion and an inspection target according to movement of a carrier portion, FIG. 7 is an enlarged view of section “E” of FIG. 4, FIG. 8 is a block diagram illustrating a control configuration of a controller according to an exemplary embodiment of the present disclosure, FIG. 9 is an operational state view illustrating a state before starting an inspection and after finishing an inspection in a welding quality inspection device for a secondary battery according to an exemplary embodiment of the present disclosure, and FIGS. 10 and 11 are operational state views illustrating a state of performing an inspection in a welding quality inspection device for a secondary battery according to an exemplary embodiment of the present disclosure.

A welding quality inspection device for a secondary battery according to an exemplary embodiment of the present disclosure may include a ring slide portion 100 disposed spaced apart from an inspection target 10 and provided in a form having a predetermined curvature, a carrier portion 200 mounted on the ring slide portion 100 and provided to be movable along the ring slide portion 100, a gripper portion 300 extended from the carrier portion 200 toward the inspection target 10 and provided to maintain a predetermined distance from the inspection target 10, a camera portion 400 mounted on the carrier portion 200 to move along the ring slide portion 100, the camera portion being arranged respectively on an upper side and a lower side of the gripper portion 300 to capture the inspection target 10 from a plurality of angles, and a driving portion 500 for driving the carrier portion 200.

As shown in FIGS. 1 and 2, the ring slide portion 100 may be provided in a form having a predetermined curvature so as to maintain a predetermined distance to the inspection target 10 (for example, a welded portion between an electrode assembly and a tab portion) from various angles.

Specifically, the ring slide portion 100 may be formed in an arc shape or a circular shape, and may be concavely bent toward the inspection target 10 as shown and may be disposed at a position spaced apart from the inspection target 10 by a predetermined distance. Accordingly, a distance from the inspection target 10 to any point of the ring slide portion 100 may always be maintained constant by a preset distance.

As illustrated in FIGS. 3 and 4, the welding quality inspection device for the secondary battery according to an exemplary embodiment of the present disclosure may further include a distance adjustment portion 600 for adjusting a distance of the ring slide portion 100 with respect to the inspection target 10.

The distance adjustment portion 600 may be provided to freely adjust a distance between the inspection target 10 and the ring slide portion 100. For example, when the type or specification of the inspection target 10 is changed, a focal distance between a camera portion 400 and the inspection target 10, which will be described later, may be changed, so a distance between the ring slide portion 100 and the inspection target 10 may be adjusted by the distance adjustment portion 600 in order to correct the focal distance between the camera portion 400 and the inspection target 10.

Herein, the distance adjustment portion 600 may include a moving plate portion 610 connected to the ring slide portion 100, a moving rail portion 620 for guiding the moving plate portion 610 to move forward toward or backward from the inspection target 10, and a ball screw portion 630 connected to the moving plate portion 610 to move the moving plate portion 610 by converting rotational motion into linear motion.

Referring to FIG. 3, the moving plate portion 610 may be configured to be directly or indirectly connected to the ring slide portion 100, and when the moving plate portion 610 moves, the ring slide portion 100 may also move in the same direction. For example, when the moving plate portion moves in a direction away from the inspection target 10, the ring slide portion 100 may also move in a direction away from the inspection target 10.

The moving rail portion 620 may guide the moving plate portion 610 to move forward toward or backward from the inspection target 10. The moving rail portion 620 may be disposed to extend in a direction toward the inspection target 10, and the moving plate portion 610 may be placed on an upper portion, thereby moving along the moving rail portion 620.

The ball screw portion 630 may be configured to be connected to the moving plate portion 610 and may provide power for moving the moving plate portion 610. The ball screw portion 630 may be operated manually or automatically, and when manually operated, a manual handle 640 may be provided at one side of the ball screw portion 630.

The ball screw portion 630 may move the moving plate portion 610 by converting rotational motion into linear motion. When the manual handle 640 is rotated in a case where the ball screw portion 630 is manually operated, a stem portion 631 of the ball screw portion 630 may be rotated and a moving body 632 connected to the moving plate portion 610 may be linearly moved, thereby moving the moving plate portion 610. When the moving plate portion 610 is moved, the ring slide portion 100 may also be moved in the same direction. Herein, the stem portion 631 and the moving body 632 may be screw-coupled to convert rotational motion into linear motion.

In addition, an exemplary embodiment of the present disclosure may further include a height adjustment portion 700 for adjusting a height of the ring slide portion 100.

The height adjustment portion 700 may be provided to appropriately adjust a height of the ring slide portion 100 with respect to the inspection target 10. When a type or specification of the inspection target 10 is changed, the height adjustment portion 700 may adjust the height of the ring slide portion 100 so that the gripper portion 300 to be described later can maintain horizontal with respect to the inspection target 10 during a setting process before the inspection.

Referring to FIG. 4, the height adjustment portion 700 may adjust a height of the ring slide portion 100 through an adjustment screw 720 that pushes or pulls an adjustment block 710 connected to the ring slide portion 100.

Meanwhile, the carrier portion 200 may be mounted on the ring slide portion 100 so as to be movable along the ring slide portion 100. The carrier portion 200 may be provided to allow other components of the present disclosure, such as the gripper portion 300, the camera portion 400, the driving portion 500, and the like to be installed on the ring slide portion 100.

The carrier portion 200 may be entirely formed as a single body and mounted on the ring slide portion 100, or may be divided into a plurality of portions and mounted on the ring slide portion 100 so that the carrier portions 200 are connected to each other, and this may be appropriately selected depending on needs of an implementer.

When power is supplied from the driving portion 500 to be described later, the carrier portion 200 may be moved along the ring slide portion 100. Since the ring slide portion 100 has an arc shape or a circular shape having a predetermined curvature, the carrier portion 200 may perform an arc motion or a circular motion along the ring slide portion 100 when provided with power.

The ring slide portion 100 may include a ring guide 110 for guiding the movement of the carrier portion 200 and for preventing from being separated, and a ring gear portion 120 disposed spaced apart from the ring guide 110 and having a gear formed on an outer surface.

Referring to FIGS. 3 and 4, the ring slide portion 100 may include the ring guide 110 and the ring gear portion 120.

The ring guide 110 may guide the carrier portion 200 to move along a predetermined movement path of the ring slide portion 100 without being separated from the ring slide portion 100. The ring guide 110 may be formed to extend along a longitudinal direction of the ring slide portion 100 from an edge of the ring slide portion 100.

In addition, a plurality of ring guides 110 may be provided, each formed on an opposing edge of the ring slide portion 100, and may be provided to have the same curvature as the ring slide portion 100. A guide roller 210 to be described later may be coupled to the ring guide 110 to guide the movement of the carrier portion 200. The guide roller 210 will be described again below.

The ring gear portion 120 may be disposed at a position spaced apart from the ring guide 110 on the ring slide portion 100, and the gear may be formed to extend along the longitudinal direction on the outer surface at the edge of the ring gear portion 120.

The ring gear portion 120 may also be formed to have the same curvature as the ring slide portion 100. For reference, a pinion gear portion 520 of the driving portion 500, which will be described later, may be gear-coupled to the ring gear portion 120 to provide power for moving the carrier portion 200. The configuration and operation of the driving portion 500 will be described again later.

Herein, the carrier portion 200 may include a guide roller 210 coupled to the ring guide 110 so that the carrier portion 200 is guided along the ring slide portion 100 without being separated.

One or more carrier portions 200 may be coupled to the ring slide portion 100, and, for example, when three carrier portions 200 are provided, the three carrier portions 200 may be coupled to be movable on the ring slide portion 100 while maintaining predetermined intervals along a longitudinal direction of the ring slide portion 100.

As shown in FIG. 5, the guide roller 210 may be a component of the carrier portion 200, and may come into contact with the ring guide 110 so that the carrier portion 200 can be guided by the ring guide 110 and can be moved along the ring guide 110.

A groove may be formed in the guide roller 210, and when the ring guide 110 is fitted into the groove, the guide roller 210 may be moved along a path without being separated from the ring guide 110. The guide roller 210 may be arranged in pairs on one side of the carrier portion 200, and at least two pairs may be provided at opposite positions of the carrier portion 200 so that the carrier portion 200 can be prevented from being separated from the ring slide portion 100.

Accordingly, as shown in FIGS. 4 and 5, one pair of guide rollers 210 may be provided on one side of the carrier portion 200 and coupled to the ring guide 110 formed at one edge side of the ring slide portion 100, and the other pair of guide rollers 210 may be provided on the other side of the carrier portion 200 (not shown in the drawings) and coupled to the ring guide 110 formed at the other edge side of the ring slide portion 100.

That is, the two pairs of guide rollers 210 provided on one carrier portion 200 may be respectively in contact with the ring guides 110 formed at both edges with the ring slide portion 100 interposed therebetween, such that the carrier portion 200 moves along the ring slide portion 100 without being separated from the ring slide portion 100.

For reference, taking FIG. 4 as an example, a total of four pairs of guide rollers 210 may be provided in FIG. 4, in which two pairs of guide rollers 210 are installed to be visible at the upper and lower portions in the drawing, respectively, and the remaining two pairs of guide rollers 210 are installed in a state not to be visible in the drawing.

Referring again to FIG. 4, the gripper portion 300 may be provided to allow the ring slide portion 100 to maintain a predetermined distance from the inspection target 10. Accordingly, the gripper portion 300 may be formed to extend a predetermined length from the carrier portion 200 mounted on the ring slide portion 100 toward the inspection target 10.

The gripper portion 300 may have an overall shape formed in a rod-like form, and the end portion thereof may be disposed to have the same height as the inspection target 10 and to be positioned close to a specific point of the inspection target 10 while maintaining a straight line with the inspection target 10 during the initial setting of the inspection. In order to adjust the distance and height of the gripper portion 300 with respect to the inspection target 10, the distance adjustment portion 600 and the height adjustment portion 700 described above may be used.

Herein, when the inspection target 10 is an electrode assembly, the gripper portion 300 may include a holder portion 310 disposed close to a tab portion 11 of the electrode assembly.

As shown in FIG. 6A, when the inspection target 10 is an electrode assembly, the tab portion 11 may protrude outside the electrode assembly, and the tab portion 11 and the electrode assembly may be connected through welding.

For reference, the quality inspection with respect to a tab welding portion for connecting the electrode assembly and the tab portion 11 may mainly check a welding connection state between a foil portion 12 of the electrode assembly and the tab portion 11. Herein, the foil portion 12 may be made of a flexible material and may be easily bent, so the soft foil portion 12 may be bent so that the tab portion 11 may not be damaged even when an external force is applied to the tab portion 11.

As shown in FIG. 6A, the holder portion 310 may be provided at an end of the gripper portion 300, and when inspecting a welded portion between the electrode assembly and the tab portion 11, the holder portion 310 may be disposed close to the tab portion 11.

At this time, the holder portion 310 may be provided to maintain the same height as the tab portion 11 of the electrode assembly during the initial setting of the inspection, and may be arranged to maintain a predetermined distance from the tab portion 11.

In addition, the holder portion 310 may be disposed to maintain a predetermined interval from the tab portion 11 without directly gripping the tab portion 11. Accordingly, it is possible to minimize damage to the tab portion 11 caused by direct contact between the holder portion 310 and the tab portion 11 during the initial setting.

Meanwhile, as shown in FIG. 6B, when the carrier portion 200 moves along the ring slide portion 100, the gripper portion 300 may also move together with the carrier portion 200, so it is possible to prevent the tab portion 11 from being damaged by allowing the foil portion 12 made of a flexible material to be bent by the holder portion 310.

Referring back to FIGS. 1 and 2, the camera portion 400 may be provided to be mounted on the carrier portion 200 and to move along the ring slide portion 100. The camera portion 400 may be configured to capture the inspection target 10, and may capture the inspection target 10 at various angles in a state of being mounted on the carrier portion 200 while performing an arc motion or a circular motion along the ring slide portion 100.

A plurality of camera portions 400 may be provided. The plurality of camera portions 400 may be respectively positioned on the upper and lower sides thereof with the gripper portion 300 interposed therebetween. Accordingly, the plurality of camera portions 400 may capture the inspection target 10 from a plurality of different angles. In addition, the camera portion 400 may capture the inspection target 10 at various angles within a preset angle range while moving together when the carrier portion 200 moves.

Herein, when the inspection target 10 is an electrode assembly, the camera portion 400 may be provided to capture a welded portion between the electrode assembly and the tab portion 11.

The camera portion 400 may adjust the imaging angle in a state of being installed in the carrier portion 200. Accordingly, the camera portion 400 may focus on an imaging region of the inspection target 10 at an optimal angle appropriate for welding quality inspection. In addition, the camera portion 400 may provide an auto-focusing function when capturing the imaging region.

The camera portion 400 may further include a lighting portion 410 for providing light to the imaging region of the inspection target 10.

Referring to FIGS. 1 and 2, the lighting portion 410 may maintain a constant illuminance when the camera portion 400 captures the imaging region of the inspection target 10 (for example, a welded portion between the electrode assembly and the tab portion 11), thereby improving imaging quality even under changes in working environments.

An angle of the lighting portion 410 may be provided to face the imaging region of the inspection target 10. In addition, an amount of light and an angle of the lighting portion 410 may be configured to be manually adjustable, and may also be configured to be automatically adjustable. When the amount of light and the angle of the lighting portion 410 are automatically adjusted, the lighting portion 410 may be automatically controlled by the controller (see FIG. 8).

The driving portion 500 may be provided to drive the carrier portion 200. When the driving portion 500 operates, power may be transmitted to the carrier portion 200, so that the carrier portion 200 can move along the ring slide portion 100.

Herein, the driving portion 500 may include a servo motor 510 and a pinion gear portion 520 for transmitting power of the servo motor 510 to the ring gear portion 120.

As shown in FIG. 7, the servo motor 510 may be configured to generate power and may be installed at a predetermined portion of the carrier portion 200. The servo motor 510 of the driving portion 500 may be precisely controlled by the controller and may be operated while precisely adjusting physical quantities such as a position, direction, and rotation speed of the carrier portion 200 with respect to the ring slide portion 100. Accordingly, the servo motor 510 controlled by the controller may move the carrier portion 200 to a position, direction, and speed desired by a user.

The pinion gear portion 520 may be connected to the servo motor 510 through a shaft. The pinion gear portion 520 may be configured to transmit the power of the servo motor 510 to the ring gear portion 120 and may be gear-coupled to the ring gear portion 120 formed in the ring slide portion 100. The pinion gear portion 520 and the ring gear portion 120 can be gear-coupled in an external manner, but are not limited thereto, and gear coupling in other ways is also possible.

Accordingly, when the servo motor 510 operates and the pinion gear portion 520 rotates, a rotational force of the pinion gear portion 520 may be transmitted to the ring gear portion 120 so that the carrier portion 200 can move along the ring slide portion 100. During this process, the carrier portion 200 may be stably moved along the movement path without being separated from the ring slide portion 100 by the ring guide 110 and the guide roller 210 described above.

Meanwhile, an exemplary embodiment according to the present disclosure may further include a controller 800 for controlling the driving portion 500 so that the camera portion 400 can capture the inspection target 10 from a preset initial position to a final position.

As shown in FIG. 8, the controller 800 may control the driving portion 500 (specifically, the servo motor 510) to control a movement position, direction, and the like of the carrier portion 200.

As the movement of the carrier portion 200 is controlled by the controller 800, the camera portion 400 installed on the carrier portion 200 may capture the inspection target 10 at various angles while moving from the preset initial position to the final position on the ring slide portion 100.

Herein, when the inspection target 10 is an electrode assembly, the controller 800 may control the driving portion 500 so that the carrier portion 200 can be positioned at a location where the gripper portion 300 is aligned in a straight line with the tab portion 11 of the electrode assembly before the start of imaging and after the end of imaging by the camera portion 400.

As shown in FIG. 9, when the inspection target 10 is an electrode assembly, the camera portion 400 may capture the welded portion between the electrode assembly and the tab portion 11, and at this time the controller 800 may control the driving portion 500 so that the carrier portion 200 can be disposed at a location (hereinafter, referred to as a “reference location”) where the gripper portion 300 is aligned in a straight line with the tab portion 11 of the electrode assembly before the start of imaging and after the end of imaging.

Before the start of imaging and after the end of imaging, controlling the carrier portion 200 to be positioned at the above-described reference location by the controller 800 may be to check whether the ring slide portion 100 maintains an appropriate distance and height with respect to the inspection target 10, which may serve as an initial setting for starting the inspection.

Accordingly, as shown in FIG. 9, when the carrier portion 200 is positioned at the reference location by the operation of the driving portion 500 under control of the controller 800, the welding quality inspection may be started, and when the inspection is finished, the carrier portion 200 may be positioned again at the reference location of FIG. 9.

In addition, when the position where the gripper portion 300 is aligned in a straight line with the tab portion 11 of the electrode assembly is assumed as 0 degrees, the controller 800 may control the driving portion 500 so that among the plurality of camera portions 400, the upper camera portion 400 can capture images within a range of +45 degrees to +15 degrees, and the lower camera portion 400 can capture images within a range of −15 degrees to −45 degrees.

As described above, a plurality of camera portions 400 may be provided respectively disposed at the upper side and the lower side thereof with respect to the gripper portion 300. When the location (reference location) where the gripper portion 300 is aligned in a straight line with the tab portion 11 of the electrode assembly is assumed as 0 degrees, the upper camera portion 400 disposed at the upper side of the gripper portion 300 may be set to capture images within a range of +45 degrees to +15 degrees.

As shown in FIG. 10, the upper camera portion 400 may start imaging from the initial position of +45 degrees and may capture up to the final position of +15 degrees as shown in FIG. 11. In this case, the carrier portion 200 may be moved in a counterclockwise direction on the drawing.

Meanwhile, the initial position of the upper camera portion 400 may not be necessarily required to start from +45 degrees during imaging, and the initial position may be +15 degrees as shown in FIG. 11, and the final position may be +45 degrees as shown in FIG. 10. In this case, the carrier portion 200 may be moved in a clockwise direction on the drawing.

In addition, the lower camera portion 400 disposed on the lower side of the gripper portion 300 may capture images within a range of −15 degrees to −45 degrees.

Referring to FIG. 10, the lower camera portion 400 may start imaging from the initial position of −15 degrees and may capture up to the final position of −45 degrees as shown in FIG. 11. In this case, the carrier portion 200 may be moved in a counterclockwise direction on the drawing.

Also, the lower camera portion 400 may not necessarily start at −15 degrees as the initial position, and the initial position may be-45 degrees as shown in FIG. 11 and the final position may be −15 degrees as shown in FIG. 10. In this case, the carrier portion 200 may be moved in a clockwise direction on the drawing.

As described above, the initial position and the final position of the upper camera portion 400 and the lower camera portion 400 may be appropriately selected depending on the needs of the implementer, and the imaging range of the camera portion 400 may not be limited to the above-described angle ranges and may be suitably changed as necessary.

Herein, the controller 800 may control the camera portion 400 to perform imaging at preset angle intervals within an imaging angle range of the camera portion 400.

When the camera portion 400 continuously captures all the imaging regions of the inspection target 10 within the imaging angle range from the initial position to the final position, not only will the inspection take a long time, but it may also be difficult to store and process the imaging data, so the controller 800 may control the camera portion 400 to capture images at preset angle intervals within the imaging angle range.

Accordingly, the controller 800 may control the camera portion 400 to perform imaging, for example, at intervals of 10 degrees. Accordingly, taking the upper camera portion 400 as an example, imaging may start at +45 degrees and the inspection target 10 may be captured at +35 degrees, +25 degrees, and +15 degrees.

The present disclosure has been described in detail through specific implementation examples. These implementation examples may be intended to specifically illustrate the present disclosure, the present disclosure may be merely illustrative of the present disclosure and may not limit the scope of the appended claims, it will be apparent to those skilled in the art that various modifications and variations to the exemplary embodiments are possible within the scope and technical spirit of the present disclosure, and it is also natural that such modifications and variations fall within the scope of the appended claims.

What is claimed is:

1. A welding quality inspection device for a secondary battery, the device comprising:
a ring slide portion disposed spaced apart from an inspection target and provided in a form having a predetermined curvature;
a carrier portion mounted on the ring slide portion and provided to be movable along the ring slide portion;
a gripper portion extending from the carrier portion toward the inspection target and provided to maintain a predetermined distance from the inspection target;
a camera portion mounted on the carrier portion to move along the ring slide portion, the camera portion being arranged respectively on an upper side and a lower side of the gripper portion to capture the inspection target from a plurality of angles; and
a driving portion for driving the carrier portion.

2. The device of claim 1, further comprising:
a distance adjustment portion for adjusting a distance of the ring slide portion with respect to the inspection target.

3. The device of claim 2, wherein the distance adjustment portion comprises:
a moving plate portion connected to the ring slide portion;
a moving rail portion for guiding the moving plate portion to move forward toward or backward from the inspection target; and
a ball screw portion connected to the moving plate portion to move the moving plate portion by converting rotational motion into linear motion.

4. The device of claim 1, further comprising:
a height adjustment portion for adjusting a height of the ring slide portion.

5. The device of claim 1, wherein the ring slide portion comprises:
a ring guide for guiding movement of the carrier portion and for preventing the carrier portion from being separated; and
a ring gear portion disposed spaced apart from the ring guide and having a gear formed on an outer surface.

6. The device of claim 5, wherein the carrier portion comprises
a guide roller coupled to the ring guide for guiding the carrier portion along the ring slide portion without being separated.

7. The device of claim 1, wherein, when the inspection target is an electrode assembly, the gripper portion comprises
a holder portion disposed close to a tab portion of the electrode assembly.

8. The device of claim 1, wherein, when the inspection target is an electrode assembly, the camera portion is provided to capture a welded portion between the electrode assembly and a tab portion.

9. The device of claim 8, wherein the camera portion further comprises
a lighting portion for providing light to an imaging region of the inspection target.

10. The device of claim 5, wherein the driving portion comprises:
a servo motor; and
a pinion gear portion for transmitting power of the servo motor to the ring gear portion.

11. The device of claim 1, further comprising:
a controller for controlling the driving portion so that the camera portion can capture the inspection target from a preset initial position to a final position.

12. The device of claim 11, wherein, when the inspection target is an electrode assembly, the controller controls the driving portion so that the carrier portion can be positioned at a location where the gripper portion is aligned in a straight line with a tab portion of the electrode assembly before the start of imaging and after the end of imaging of the camera portion.

13. The device of claim 11, wherein, when the location where the gripper portion is aligned in a straight line with the tab portion of the electrode assembly is assumed as 0 degrees,
the controller control the driving portion so that among a plurality of camera portions, the camera portion on the upper side of the gripper portion can capture images within a range of +45 degrees to +15 degrees, and the camera portion on the lower side of the gripper portion can capture images within a range of −15 degrees to −45 degrees.

14. The device of claim 13, wherein the controller controls the camera portion to capture images at preset angular intervals within an imaging angle range of the camera portion.
